(19) United States
(12) Patent Application Publication
(10) Pub. No.: US 2013/0279336 A1
(43) Pub. Date: Oct. 24, 2013

(54) COMMUNICATION SYSTEM

(71) Applicant: NOKIA SIEMENS NETWORKS OY, (US)

(72) Inventors: Roland Antonius WOELKER, Espoo (FI); Mikko Tapani SUNI, Espoo (FI)

(21) Appl. No.: 13/845,892

(22) Filed: Mar. 18, 2013

Related U.S. Application Data
(60) Provisional application No. 61/611,746, filed on Mar. 16, 2012.

(51) Int. Cl. H04W 28/02

(52) U.S. Cl. CPC H04W 28/02
USPC 370/235

(57) ABSTRACT

A method comprising determining charging and policy rules for a data connection between at least one core network node and at least one radio access network node comprising a traffic-offload function.

### FIELD

Some embodiments relate to a mobile communication system. In particular but not exclusively some embodiments relate to policy and charging in a mobile communication system.

### BACKGROUND

A communication system can be seen as a facility that enables communications between two or more entities such as a communication device, e.g. mobile stations (MS) or user equipment (UE), and/or other network elements or nodes, e.g. Node B or base transceiver station (BTS), associated with the communication system. A communication system typically operates in accordance with a given standard or specification which sets out what the various entities associated with the communication system are permitted to do and how that should be achieved.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS).

A mobile communication network may logically be divided into a radio access network (RAN) and a core network (CN). The core network entities typically include various control entities and gateways for enabling communication via a number of radio access networks and also for interfacing a single communication system with one or more communication systems, such as with other wireless systems, such as a wireless Internet Protocol (IP) network, and/or fixed line communication systems, such as a public switched telephone network (PSTN). Examples of radio access networks may comprise the UMTS terrestrial radio access network (UTRAN) and the GSM/EDGE radio access network (GERAN).

A geographical area covered by a radio access network is divided into cells defining a radio coverage provided by a transceiver network element, such as a Node B. A single transceiver network element may serve a number of cells. A plurality of transceiver network elements is typically connected to a controller network element, such as a radio network controller (RNC). The logical interface between an RNC and a Node B, as defined by the third generation partnership project (3GPP), is called an lub interface.

A user equipment or mobile station may be provided with access to applications supported by the core network via the radio access network. In some instances a packet data protocol (PDP) context may be set up to provide traffic flows between the application layer on the user equipment and the application supported by the core network.

### SUMMARY

According to a first aspect there is provided a method comprising determining charging and policy rules for a data connection between at least one core network node and at least one radio access network node comprising a traffic-offload function.

According to another aspect there is provided a method comprising receiving information relating to policy and charging from a plurality of nodes in a communication network for a data connection comprising a traffic-offload function.

Preferably the plurality of nodes comprises at least one radio access network node and at least one core network node.

Preferably the traffic-offload function is comprised in the radio access network node.

Preferably the core network node comprises a gateway general packet radio service support node (GGSN)

Preferably the radio access network node comprises a radio network controller (RNC).

Preferably the method comprises forwarding the information to at least one charging server.

Preferably the method comprises forwarding the information to at least one policy server.

Preferably the method comprises determining charging and policy rules for different traffic flows of the same data connection.

Preferably the method comprises ensuring that the charging and policy rules are executed in one of the at least one core network node and the at least one radio access network node for any one traffic flow.

Preferably the method comprises informing one of the at least one core network node and the at least one radio access network node that it is to execute the charging and policy rules.

Preferably the method comprises informing the other of the at least one core network node and the at least one radio access network node that it is not to execute the charging and policy rules.

Preferably the method comprises delegating policy and charging rules to the radio access network node.

Preferably the method comprises generating at least one usage report.

Preferably the method comprises aggregating the policy and charging rules of a plurality of nodes.

Preferably the method comprises coordinating charging and policy rules updates between the at least one core network node and the at least one radio access network node.

Preferably the data comprises packet data.

In another aspect there is provided a method comprising enforcing policy and charging rules in a radio access network node for a data connection between said radio access network node and a core network node.

Preferably said data connection comprises a traffic offload function.

In another aspect there is provided a computer program product stored on a medium for causing an apparatus to perform the method as described herein.

In another aspect there is provided an apparatus comprising at least one processor, and at least one memory including computer program code, the at least one memory and the computer program code configured to, with the at least one processor, cause the apparatus at least to perform determining charging and policy rules for a data connection between at least one core network node and at least one radio access network node comprising a traffic-offload function.

In another aspect there is provided an apparatus comprising means to cause the apparatus at least to perform determining charging and policy rules for a data connection between at least one core network node and at least one radio access network node comprising a traffic-offload function.

In another aspect there is provided an apparatus comprising at least one processor, and at least one memory including computer program code, the at least one memory and the computer program code configured to, with the at least one processor, cause the apparatus at least to perform receiving information relating to policy and charging from a plurality of nodes in a communication network for a data connection comprising a traffic-offload function.

In another aspect there is provided an apparatus comprising means to cause the apparatus at least to perform receiving information relating to policy and charging from a plurality of nodes in a communication network for a data connection comprising a traffic-offload function.

Preferably the apparatus is configured to forward the information to at least one charging server.

Preferably the apparatus is configured to forward the information to at least one policy server.

Preferably the plurality of nodes comprises a radio access network node and a core network node.

Preferably the core network node comprises a gateway general packet radio service support node (GGSN)

Preferably the radio access network node comprises a radio network controller (RNC).

Preferably the apparatus is configured to determine charging and policy rules for different traffic flows of the same data connection.

Preferably the apparatus is configured to ensure that the charging and policy rules are executed in one of the at least one core network node and the at least one radio access network node for any one traffic flow.

Preferably the apparatus is configured to inform one of the at least one core network node and the at least one radio access network node that it is to execute the charging and policy rules.

Preferably the apparatus is configured to inform the other of the at least one core network node and the at least one radio access network node that it is not to execute the charging and policy rules.

Preferably the apparatus is configured to delegate policy and charging rules to the radio access network node.

Preferably the apparatus is configured to generate at least one usage report.

Preferably the apparatus is configured to aggregate the policy and charging rules of a plurality of nodes.

Preferably the apparatus is configured to coordinate charging and policy rules updates between the at least one core network node and the at least one radio access network node.

Preferably the data comprises packet data.

In another aspect there is provided an apparatus comprising at least one processor, and at least one memory including computer program code, the at least one memory and the computer program code configured to, with the at least one processor, cause the apparatus at least to perform enforcing policy and charging rules in a radio access network node for a data connection between said radio access network node and a core network node.

In another aspect there is provided an apparatus comprising means to cause the apparatus at least to perform enforcing policy and charging rules in a radio access network node for a data connection between said radio access network node and a core network node.

Preferably said data connection comprises a traffic offload function.

In another aspect there is provided a chipset comprising apparatus as described herein.

### BRIEF DESCRIPTION OF DRAWINGS

Embodiments of the present invention are described below, by way of example only, with reference to the accompanying drawings, which are included to provide a further understanding of the invention and constitute a part of this specification. The drawings illustrate exemplary embodiments of the invention and together with the description help to explain the principles of the invention. In the drawings:

FIG. 1 shows a schematic view of a general exemplary situation in which some embodiments can be realised;

FIG. 2 shows a schematic view of a general communications apparatus according to some embodiments;

FIG. 3 shows a schematic general overview of a radio access network and a core network according to some embodiments;

FIG. 4 shows a schematic view of an exemplary system in which some embodiments can be realised;

FIG. 5 shows an exemplary communication flow according to some embodiments;

FIG. 6 shows a schematic view of a communications apparatus according to some embodiments;

FIG. 7 shows an exemplary mode of operation for a policy and charging (PCC) mediator according to some embodiments; and

FIG. 8 shows an exemplary mode of operation for a policy and charging enforcement function (PCEF) according to some embodiments.

### DETAILED DESCRIPTION OF SOME EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features/structures that have not been specifically mentioned.

Reference will now be made in detail to the embodiments of the present invention, examples of which are illustrated in the accompanying drawings.

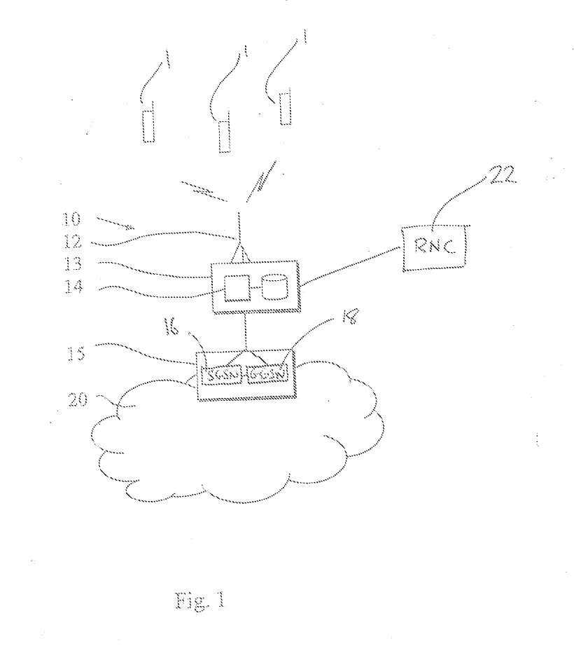

FIG. 1 shows an example of a mobile communication system 10. Mobile communications apparatus or user equipment (UE) 1 can typically access wirelessly a mobile network system via at least one base station 12 or similar wireless transmitter and/or receiver node of the access system. A base station site typically provides one or more cells of a cellular system. In the FIG. 1 example the base station 12 is configured to provide a cell, but could provide, for example, three sectors, each sector providing a cell. Each mobile communications apparatus 1 and base station 12 may have one or more radio channels open at the same time and may communicate with more than one other station. In addition to communications with the base station, the communications apparatus can be in direct communication with the other communication apparatus.

A base station is typically controlled by at least one appropriate control apparatus so as to enable operation thereof and management of mobile communication devices in communication with the base station. A control entity of a base station can be interconnected with other control entities. In FIG. 1 the control apparatus is shown to be provided by block 13. An appropriate controller apparatus may comprise at least one memory, at least one data processing unit and an input/output interface. The controller is thus typically provided with memory capacity and at least one data processor 14. It shall be understood that the control functions may be distributed between a plurality of controller units and/or that a part of the control may be provided by a control apparatus controlling a plurality of base stations. The controller apparatus for a base station may be configured to execute an appropriate software code to provide the control functions as explained below in more detail.

The base station 12 is connected to a radio network controller (RNC) 22. The RNC 22 may be connected to one or more further base stations (not shown). The user equipment 1, base station 12 and RNC 22 may be considered to collectively comprise a radio access network (RAN).

In the FIG. 1 example the base station node 12 of the access is connected to a wider communication network 20 via block 15. Communication network 20 may for example be an external IP network. A communication system may be provided by one or more interconnected networks and the elements thereof, and one or more gateway nodes may be provided for interconnecting various networks. In FIG. 1 the block 15 is shown to comprise a Serving GPRS Support Node (SGSN) 16 and a Gateway GPRS Support Node (GGSN) 18. As is known in the art, the SGSN and the GGSN are used to establish a call session between the user equipment 1 and the external IP network 20. The GGSN is responsible for the interworking between the mobile communication system 10 and the external IP network 20. The SGSN is responsible for the delivery of data packets from and to the mobile stations within its geographical service area.

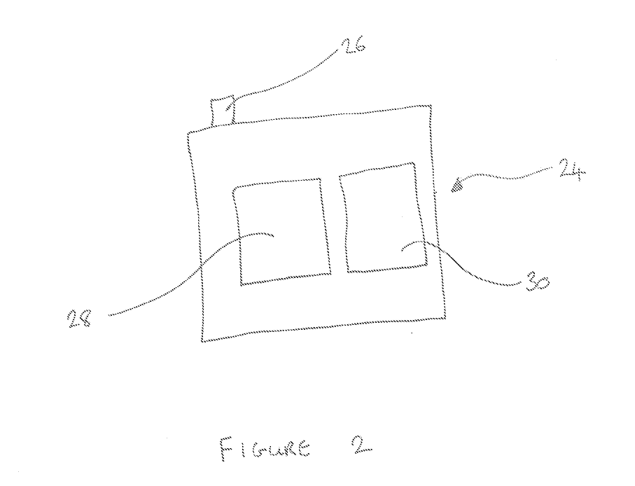

It shall be appreciated that, as with base station 12, either or both of the SGSN 16 and GGSN 18 may comprise at least one memory, at least one data processing unit and an input/output interface. This is shown schematically in FIG. 2 in which an apparatus 24 is shown comprising an input/output interface 26, at least one memory 28 and at least one data processing unit 30. The controller is thus typically provided with memory capacity and at least one data processor. It shall be understood that the control functions may be distributed between a plurality of controller units and/or that a part of the control may be provided by a control apparatus controlling a plurality gateway nodes. The controller apparatus for a gateway node may be configured to execute an appropriate software code to provide the control functions as explained below in more detail.

The communications apparatus 1 can be provided with wireless access to the communication system based on various access techniques, such as code division multiple access (CDMA), wideband CDMA (WCDMA), time division multiple access (TDMA), frequency division multiple access (FDMA), Orthogonal Frequency-Division Multiple Access (OFDMA), space division multiple access (SDMA), and so on.

Embodiments may be used where there are local break out and off load solutions. This may be in the context of a 3GPP radio environment or any other suitable environment. In some embodiments, applications may be deployed to offload points using for example cloud style application deployments.

Local breakout function may provide a mechanism to serve traffic by local applications. In other words, Internet content or the like is brought to a local breakout point. There are many use cases of localization. By way of example, this may be one or more of a local content delivery network (CDN), local transparent caching, local content optimization for a mobile terminal and/or network, local hosting of other kind of services (used by mobile terminals), and local serving of machine-to-machine (M2M) terminals, for example aggregation functions or the like.

Local breakout may be applied alternatively or additionally to other types of radio networks, such as Wi-Fi, WiMax and Femto network. In such embodiments the offload may be between core network and Internet transit/peering.

Currently, local breakout devices or mobile gateways may be separate from radio devices and application servers. The local breakout devices or mobile gateways currently need to be connected and integrated with complex type solutions through site transport infrastructure. With integration, the traffic routing policy may ensure that the intended application traffic is separated from the other traffic and that the traffic routing policy is in synchronisation with the availability or life-cycle of an application.

“Local breakout” scenarios are specified in 3GPP rel 10 under the name SIPTO (selected IP traffic offload, 3GPP TR 23.829 v10.1). SIPTO provides the system with the ability to select specific IP flows and route them to the local network, as opposed to tunneling them to the home network. One of the concepts for 3G networks is the so-called “leaky bearer” traffic flow break-out, also called Traffic Offload Function (TOF), described in section “5.5 Solution 4: Selected IP Traffic Offload at lu-PS” of TR 23.829. It allows extracting or inserting IP flows of an existing PDP context according to pre-configured traffic filters at the RNC or at lu interface of the radio access network. Hereon the terms Traffic Offload Function and “leaky bearer” may be used interchangeably.

This is a flexible break-out concept, and in some embodiments is without involvement of or impact on the UE. It provides local access to PDP context traffic flows and enables deployment and execution of applications at the RAN like CDN solutions (content delivery), content delivery optimization, caching solutions or others. Since in some embodiments there is no involvement from UE, this leaves full freedom to an operator to define where and when such breakout applications are enabled, without needing to consider changes in configurations or functionality of mobile terminals.

These local applications can benefit from the proximity to the radio (e.g. location awareness, lower latency) and of having access to radio information, e.g. radio cell load or a certain UE's radio condition. Combining access awareness to these applications, more efficient use of network resources, more flexible content delivery solutions and better end-user experience can be expected.

In 3GPP 3G networks the mobile gateway (GGSN) is the control point for policy control and charging, including the PCEF (policy and charging enforcement) function. It connects on one hand via Gx (3GPP specified policy control interface), Gy (3GPP specified online charging interface) interfaces to the policy control and charging backend systems and on the other hand enforces the corresponding usage and charging policies of the PDP contexts of the users.

Policy control and charging is applied at a level of a PDP context by a logical entity called PCEF in the Gx reference point, or CTF (Charging Trigger Function) in case of Gy reference point. A mobile terminal may have multiple PDP contexts, each with different policy and charging rules. Assumption in existing specifications and implementations is that a single PDP context is charged and policy enforced at single point in the network, which is GGSN.

In the above described “leaky bearer” offload concept some traffic flows of a PDP context will be offloaded and modified locally. Even traffic flows may be terminated locally, and new traffic generated by applications integrated in RAN. It means that the GGSN may not have full visibility of the PDP context activity, e.g. transferred data volume, content type, active usage periods etc. As a result, policy and charging enforcement for local traffic flows is not always possible at GGSN.

Another issue is that Gx and Gy interfaces do not support split charging and enforcement of a single PDP context at two separate locations—at RAN and GGSN. This would be necessary, since different traffic flows of the same PDP context are handled at two different places: 1) the local application traffic at RAN and, 2) the central non-offloaded traffic at the core.

Another issue is online charging at Gy reference point (Diameter Credit Control Application, DCCA, 3GPP TS 32.299) with its real time quota control of individual users by the online charging system (OCS), and fair usage policy by policy control at Gx reference point (Diameter Policy Control and Charging application, 3GPP TS 29.212) that requires volume based reporting to policy server. These are used on most mobile networks today in order to control and charge subscribers. There are many other types of complications arising from rich charging and policy rules, like time/activity based charging, per service flow policy and charging (PCC), and time-limited rules, redirect rules etc enabled by Gy and Gx interfaces.

There are two main kinds of offload solutions, one based on “leaky bearer” and another based on local/distributed mobile gateways (GGSN in case of UTRAN macro network), both described in several variants in 3GPP TR 23.829.

The local GW concept requires involvement of the UE. Network initiated PDP context setup is seldomly allowed due to security issues and complexity of configurations. UE initiated setup of PDP context would mean that UE should know what traffic or applications are subject to breakout in order to initiate a PDP context to the local GGSN for special applications or content requests. Additionally, UE should know what APN (access point name) to use for the breakout. As a result:
UEs should support application specific PDP contexts. This is not supported by all Smart Phones, and even less by USB dongles.
UEs should support IP route based selection of PDP contexts. This is not known to be supported.
UEs may require a number of operator specific configurations, which would be subject to change as new services or applications are introduced.
PDP context activation has a delay, and it would increase signaling load in the network.

In addition the number of Gx and Gy interfaces towards the operator backend system may increase significantly as a result of local gateways, and there may be considerable integration effort at introduction of larger number of gateways into a network.

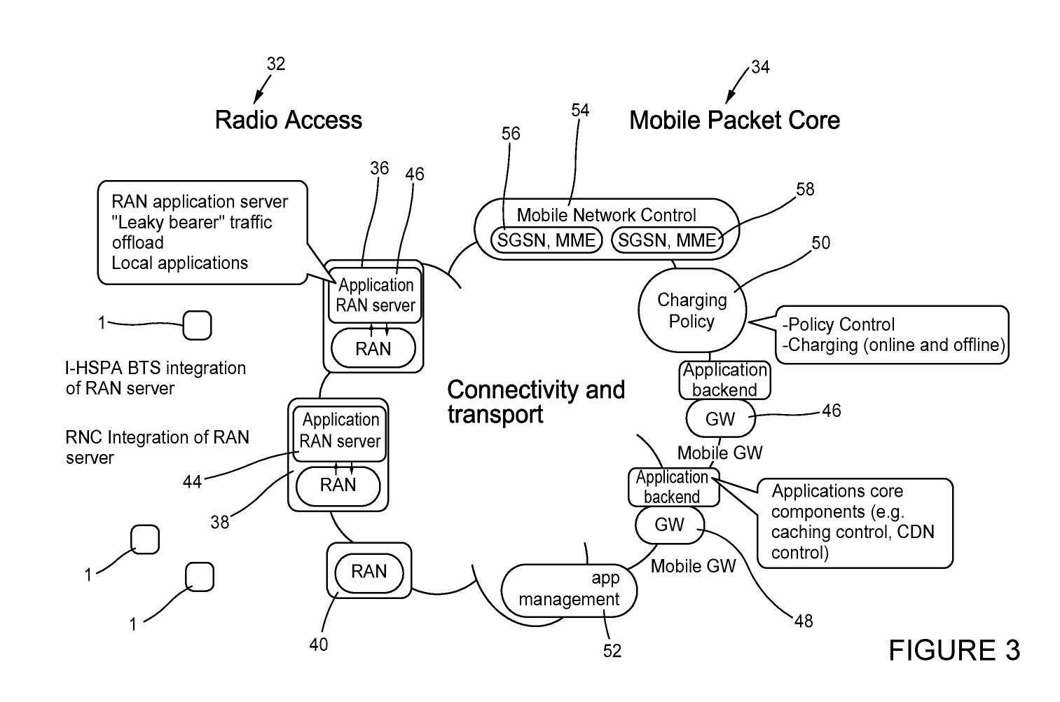

FIG. 3 shows a high level network architecture with radio access network-RAN application server (RAN-AS) according to some embodiments of the present invention.

The network architecture broadly comprises a radio access side 32 and a mobile packet core 34. The radio access side comprises UEs 1 and RAN nodes 36, 38 and 40. The RAN node 36 comprises integrated RAN application server 42. The RAN node 38 comprises integrated RAN application server 44.

It should be appreciated that other embodiments are also envisaged, such as where application functionality is integrated into RAN node (e.g. RNC) itself, without a server. Functionality may be considered to mean anything that may impact policy control charging, i.e. modifying, terminating or originating end-to-end user data.

The mobile packet core 34 comprises mobile gateway nodes 46 and 48. It also comprises a charging policy control function 50 and a application management function 52. Mobile packet core 34 further comprises mobile network control block 54, which itself comprises SGSNs and MMEs (mobile management entities) 56 and 58.

The RAN servers 42 and 44 allow the integration and execution of applications in RAN. Traffic offload to/from RAN server happens with the “leaky bearer” concept. Applications may be solely located at RAN, or have a backend instance running at packet core. The charging and policy backend systems are located at the core network side.

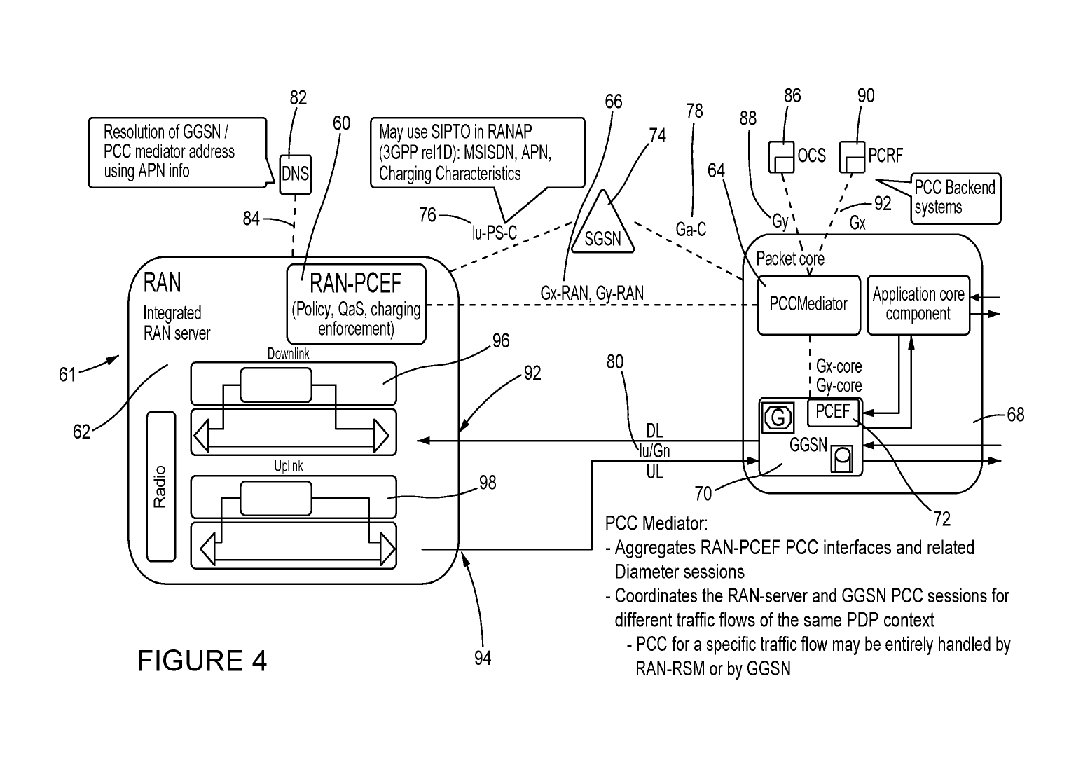

FIG. 4 shows one embodiment of a policy and charging (PCC) structure handling both local applications integrated into the RAN server and applications served from the core or the Internet. The system of FIG. 4 comprises PCEF/CTF function 60 at RAN server 62 side (RAN-PCEF/CTF) of RAN 61 providing the policy and charging interfaces towards PCC mediator 64 and implementing local policy and charging rule enforcement. It further comprises Gx-RAN and Gy-RAN interfaces 66 based on 3GPP Gx, Gy standards, possibly with minor non-standard extensions (e.g. allowing negative accounting of traffic if needed).

The structure further comprises charging and PCC mediator 64 at the packet core side 68 with one or more of the following functionality:
Coordinating charging and PCC rules and their execution between RAN 61 and GGSN 70 side for different traffic flows of the same PDP context
Ensuring that charging or PCC rule for any individual traffic flow is only applied once, either by ensuring PCC or charging rule is executed only in one PCEF or charging trigger function (CTF) (RAN or GGSN) for any given traffic flow, be it related to charging or policing. Some examples of functionality include: volume reporting of terminated flows at RAN without GGSN involvement; for flows being modified in RAN 61, PCC mediator 64 may formulate complement rules for two PCEF points with same traffic filter template, where one PCEF reports volume for a traffic flow, while other PCEF is instructed to pass it through without reporting
PCC mediator 64 may also move a part or entire CTF rule being executed in RAN-PCEF and remove it from GGSN-CTF
correcting reported usage at mediator, e.g. in case amount of delivered traffic was increased or decreased at second PCEF (may be needed in OCS based scenarios (without PCRF)); coordinating DCCA (Diameter credit control application, 3GPP TS 32.299) protocol over Gy, and Diameter policy control protocol over Gx reference points, between multiple PCEF points and OCS.
Proxying installed rules; splitting quota and concatenating usage reports; terminate Diameter sessions to each directions; generate responses when proxied rule or quota exists
Shielding GGSN PCEF 72 functionality from impacts of “leaky bearer” offload and RAN-server applications
Terminate Diameter session between mediator and each PCEF/CTF, making mediator to look like OCS and/or PCRF
Aggregating the PCC interfaces of multiple RAN-server nodes (potentially a large number of nodes) as a PCC front-end
Local termination of Diameter sessions hides mobility events like frequent PCC session activation and release, e.g. due to handovers
Coordinating PCC and charging rule updates and quota control upon mobility events; when RAN-PCEF/CTF points are added and removed for a PDP context
Splitting & combining quota and reported usage from CCR and CCA messages both towards PCEF/CTFs and OCS/PCRF
Providing the standard PCC interfaces for the entire PDP context towards PCC backend systems, so that RAN-AS impacts are hidden from the backend
Terminate Diameter session between mediator and OCS/PCRF, making mediator looking like single PCEF/CTF
Mediator address resolution, using either Access Point Name (APN) from RANAP SIPTO enhancement of 3GPP rel10 (3GPP TS 25.413), or by resolution service provided by PCC mediators using for example {IMSI, NSAPI} as keys, to resolve the address of the PCC mediator handling given RAB/PDP context.

Some embodiments may use transport layer security (TLS), IPSec or similar to secure connection between RAN-PCEF/CTF and PCC mediator.

FIG. 4 also shows communication between packet core 68 and RAN 61 via SGSN 74. Communication between SGSN 74 and RAN 61 takes place on the lu-PS-C interface 76; and communication between the SGSN 74 and the packet core 68 takes place on the Gn-C interface 78.

The GGSN communicates with RAN server 62 on the lu/Gn interface on the downlink and the uplink.

RAN server 62 is connected to domain name server (DNS) 82 via connection 84.

On the packet core side 68 the PCC mediator 64 is connected to OCS 86 via Gy interface 88 and to policy and charging rules function 92 via Gx interface 92. The OCS 86 and policy control and charging rules function (PCRF) 90 may collectively be considered to comprise the PCC backend system.

The integrated RAN server 62 comprises a downlink interface 92 and an uplink interface 94 for communications with the GGSN. As can be seen from FIG. 4, at least some downlink traffic can be offloaded to the RAN server 62 as represented by block 96. Likewise at least some uplink traffic can be offloaded to RAN server 62, as represented by bock 98.

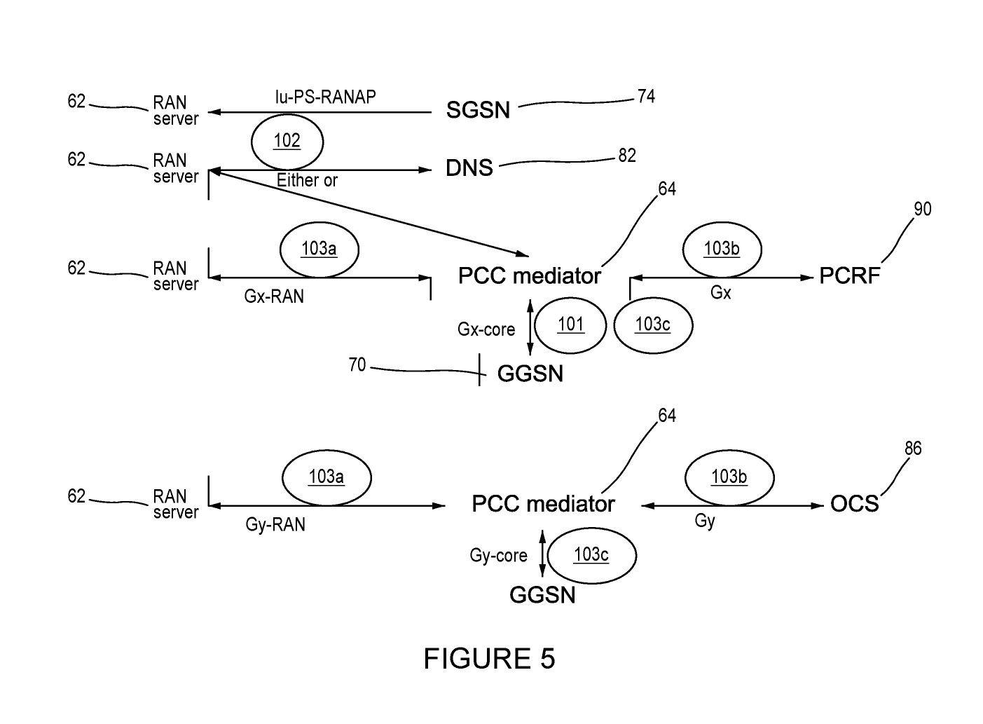

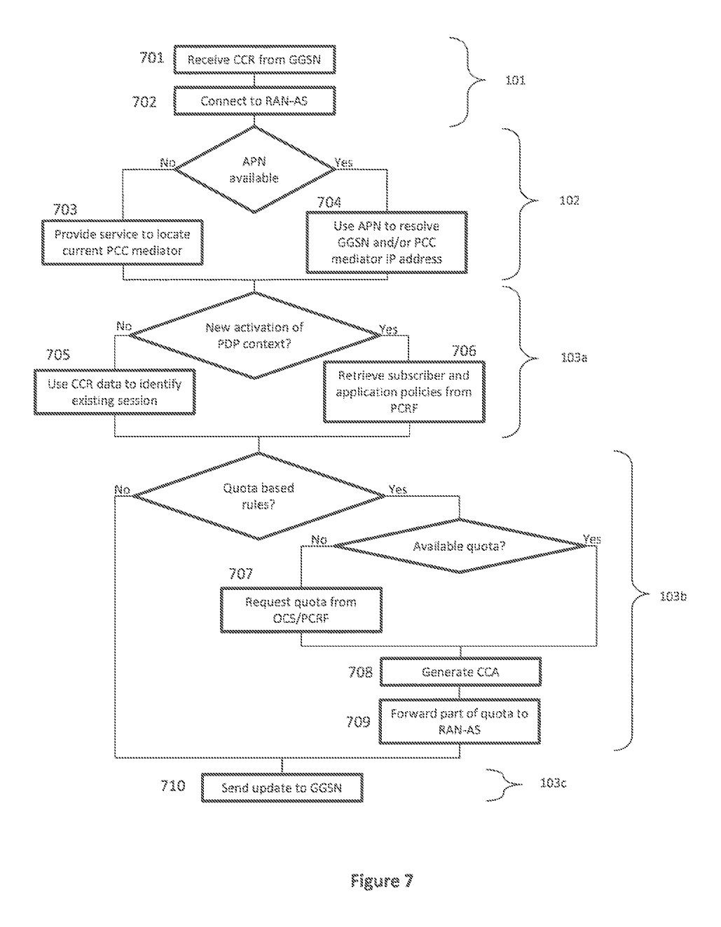

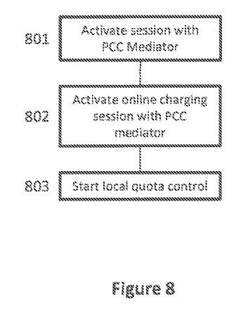

A mode of operation according to one embodiment is shown in FIGS. 5, 7 and 8. References in the 7XX format refer to FIG. 7 which shows an exemplary mode of operation for a PCC mediator according to some embodiments. References in the 8XX format refer to FIG. 8 which shows an exemplary mode of operation for a PCEF according to some embodiments. All other references refer to FIG. 5 which shows an exemplary communication flow according to some embodiments

During PDP context creation at step 101, GGSN 70 sends credit control request (CCR) (701) type INITIAL_REQUEST to the PCC mediator 64. It will store new session (702) by using keys MSISDN, IMSI, and NSAPI at least. It will forward CCR to OCS/PCRF. When receiving CCA, it will store PCC and charging rules, and may either forward entire quota or withhold part of it.

At step 102, during RAB activation RAN server 62 will connect to PCC mediator 64.
a) It may receive SIPTO parameters in RANAP from SGSN 74, i.e. MS-ISDN, charging IDs, access point name (APN). RAN-AS uses the APN information of the respective RAB/PDP context to resolve the GGSN and/or PCC mediator IP address, for example through DNS query (704).
b) If APN is not available, PCC mediator(s) 64 may provide a service (703) to locate correct PCC mediator serving the given RAB by using {IMSI, NSAPI} or other parameters as key. In this case, it requires that GGSN 70 has created Diameter session(s) already to PCC mediator 64 over Gy and/or Gx. Diameter response to RAN PCC may be delayed until GGSN has initiated a session.

RAB activation can happen either due to new PDP context activation or due to relocation, if a UE moves/is moved into RAN server coverage area. At step 103 RAN-PCEF/CTF server 60 uses MSISDN (if available), IMSI, RAB-ID (NSAPI), APN (if available) and GGSN/PCC mediator address to activate (801) policy session with PCC mediator (103a).

RAN-PCEF 60 may also include traffic filters for locally served traffic flows into the CCR, to enable PCC mediator to decompose PCC rules and disable it for these traffic flows in GGSN PCEF, if necessary.

PCC mediator will use MSISDN or IMSI and NSAPI supplied by GGSN in the initial CCR to identify existing session and its state, including active rules and withheld quota (705).

If not yet available e.g. because it is a new activation of a PDP context, the PCC mediator 64 will retrieve subscriber and application policies (706) from PCRF 90 at step 103b. This also includes whether RSM applications are enabled for the subscriber. This requires that RAN server 62 has supplied APN.

Otherwise, Diameter response to RAN-server 62 may be deferred until GGSN 70 initiates session for the same PDP context.

If PDP context has active quota-based rules, PCC mediator 64 checks withheld quota. If available, it will generate (708) credit control application (CCA) towards RAN-AS. If not, it will request more quota (707) from OCS/PCRF, and upon receiving CCA, will forward part of available quota to RAN-AS (709).

PCC mediator 64 will provide the relevant active policy rules to RAN-AS, which will return the respective active traffic filters, which are locally policed and charged at step 103a.

PCC mediator 64 will update (710) towards GGSN 70 which traffic filters will be under PCC at RAN-AS and are therefore excluded from central PCC at step 103c. This ensures that traffic flows are not policed and/or charged at two different places.

When UE leaves the RAN-AS coverage area the respective policy session is terminated and default rules are applied at GGSN 70 at step 103c unless the UE becomes active in other RAN server coverage area.

The RAN-AS activates online charging session (802) with PCC mediator 64 based on the received policy rules and starts local quota control (803). The PCC mediator 64 will manage the quota split between GGSN 70 and RAN-AS (103a, 103c ) towards OCS (Online Charging System, 103c ), or PCRF in case PCRF based charging is used.

When UE leaves the RAN-AS coverage area, the respective charging session is terminated and default rules applied at GGSN unless the UE becomes active in other RAN server coverage area.

In view of the above, aspects of some embodiments are:
Introducing PCEF/CTF to RAN server, which enables local dynamic policies and online charging control.
Introducing a PCC mediator at the packet core side which allows hiding network changes due to RAN-PCEF/CTF introduction from existing GGSN and the PCC backend systems, i.e. that PCC and charging for different traffic flows of the same PDP context happens at different locations in the network; aggregating PCC and charging interfaces from large number of RAN-PCEF/CTF; hiding UE mobility in terms of frequent PCC session activation and release due to handovers/relocations
Gx-RAN and Gy-RAN interfaces enabling local PCC based on operator subscription and application policy
Functionality in the PCC mediator 64 which: ensures that PCC for one traffic flow is only done either at RAN-AS or GGSN. This is enabled e.g. by the exchange of application offload traffic filters applied at RAN-AS via Gx-RAN to PCC mediator. PCC mediator will enable/disable respective PCC rules at GGSN. This also coordinates quota control for different traffic flows of one PDP context between RAN-PCEF and GGSN-PCEF.

Some embodiments may allow introduction of applications into RAN, applying policy and charging to those applications, without modifying either existing PCC and charging backends or GGSNs in operator networks. This may obviate the need for modifications to the charging systems which may be expensive for operators.

The function of the PCC mediator 64 has been discussed with respect to the system architecture of the accompanying figures. It should be appreciated that the PCC mediator 64 may be employed in differing system architectures. For example in FIG. 4 the PCC mediator is located in the packet core 68. It should be appreciated that in other embodiments the PCC mediator may be located outside the packet core; for example it could be located in the radio access network 62.

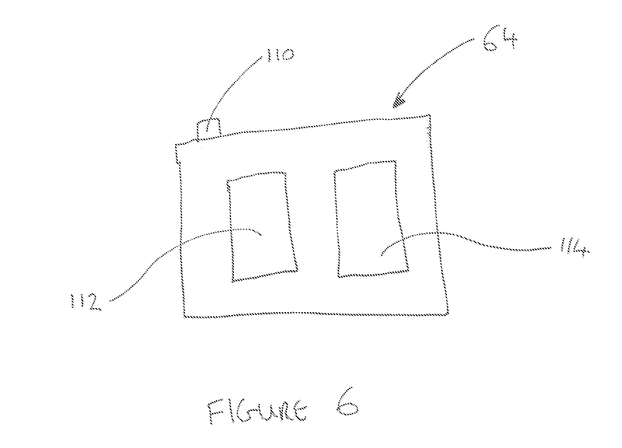

The PCC mediator 64 may be comprised in another entity. For example the PCC mediator could be comprised in a GGSN, an SGSN or a RAN. Alternatively the PCC mediator may comprise a separate entity in its own right. As shown in FIG. 6 the PCC mediator 64 may comprise an input/output interface 110, at least one memory 112 and at least one data processing unit 114. The PCC mediator 64 is thus typically provided with memory capacity and at least one data processor. It shall be understood that the control functions may be distributed between a plurality of controller units and/or that a part of the control may be provided by a control apparatus controlling a plurality of nodes. The controller apparatus for a node may be configured to execute an appropriate software code to provide the control functions.

Although the term “PCC mediator” is used in the description, it should be appreciated that other terms may be used to describe the PCC mediator. That is the term “PCC mediator” covers any entity which carries out the functionalities described. Thus the term PCC mediator covers any entity which provides the function of coordinating charging and policy between core network nodes and radio access network nodes in a system incorporating traffic offload function or a “leaky bearer”. Optionally the PCC mediator may also provide charging and policy reports to a separate online charging server and/or policy control function.

An appropriately adapted computer program code product or products may be used for implementing the embodiments, when loaded on an appropriate data processing apparatus, for example for determining geographical boundary based operations and/or other control operations. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is also noted herein that while the above describes exemplifying embodiments of the invention, there are several variations and modifications which may be made to the disclosed solution without departing from the scope of the present invention.

1. A method comprising determining charging and/or policy rules for a traffic-offload function of a data connection.

2. A method comprising receiving information relating to policy and/or charging from at least one node, said information being associated with a traffic-offload function of a data connection.

3. The method as claimed in claim 2, wherein the at least one node comprises at least one of:
at least one radio access network node; and
at least one core network node.

4. The method as claimed in claim 3, wherein the traffic-offload function is provided by the radio access network node.

5. The method as claimed in claim 2, comprising forwarding the information to at least one of:
at least one charging server; and
at least one policy server.

6. The method as claimed in claim 2, comprising determining different charging and/or policy rules for different traffic flows of the same data connection.

7. The method as claimed in claim 6, comprising causing the charging and/or policy rules to be executed in as least one of:
the at least one core network node; and
the at least one radio access network node.

8. The method as claimed in claim 6, comprising at least one of:
informing one of the at least one core network node and the at least one radio access network node that it is to execute the charging and/or policy rules; and
informing the other of the at least one core network node and the at least one radio access network node that it is not to execute the charging and/or policy rules.

9. The method as claimed in claim 6, comprising delegating the policy and/or charging rules to the radio access network node.

10. The method as claimed in claim 2, comprising generating at least one usage report.

11. The method as claimed in claim 6, comprising aggregating the policy and/or charging rules of a plurality of nodes.

12. The method as claimed in claim 3, comprising coordinating charging and/or policy rules updates between the at least one core network node and the at least one radio access network node.

13. A method comprising enforcing policy and/or charging rules in a radio access network node for a traffic off-load function of a data connection.

14. An apparatus comprising at least one processor, and at least one memory including computer program code, the at least one memory and the computer program code configured to, with the at least one processor, cause the apparatus at least to determine charging and/or policy rules for a traffic-offload function of a data connection.

15. An apparatus comprising at least one processor, and at least one memory including computer program code, the at least one memory and the computer program code configured to, with the at least one processor, cause the apparatus at least to receive information relating to policy and/or charging from at least one node, said information being associated with a traffic-offload function of a data connection.

16. The apparatus as claimed in claim 15, wherein the at least one memory and the computer program code are configured with the at least one processor cause said apparatus to forward the information to at least one of:
at least one charging server; and
at least one policy server.

17. The apparatus as claimed in claim 15, wherein said apparatus is provided in one of a radio access network node and a core network node.

18. The apparatus as claimed in claim 15, wherein the at least one memory and the computer program code are configured with the at least one processor cause said apparatus to determine different charging and/or policy rules for different traffic flows of the same data connection.

19. The apparatus as claimed in claim 15, wherein the at least one memory and the computer program code are configured with the at least one processor cause said apparatus to cause that the charging and/or policy rules to be executed in one of the at least one core network node and the at least one radio access network node.

20. The apparatus as claimed in claim 17, wherein the at least one memory and the computer program code are configured with the at least one processor cause said apparatus to at least one of:
inform one of the at least one core network node and the at least one radio access network node that it is to execute the charging and/or policy rules; and
inform the other of the at least one core network node and the at least one radio access network node that it is not to execute the charging and/or policy rules.

21. The apparatus as claimed in claim 17, wherein the at least one memory and the computer program code are configured with the at least one processor cause said apparatus to delegate policy and charging rules to the radio access network node.

22. The apparatus as claimed in claim 15, wherein the at least one memory and the computer program code are configured with the at least one processor cause said apparatus to to aggregate the policy and charging rules of a plurality of nodes.

23. The apparatus as claimed in claim 17 wherein the at least one memory and the computer program code are configured with the at least one processor cause said apparatus to coordinate charging and/or policy rules updates between the at least one core network node and the at least one radio access network node.

24. An apparatus comprising at least one processor, and at least one memory including computer program code, the at least one memory and the computer program code configured to, with the at least one processor, cause the apparatus at least to enforce policy and charging rules in a radio access network node for a traffic-offload function of a data connection.

25. An apparatus comprising means for determining at least one of charging and/or policy rules for a traffic-offload function of a data connection.

26. An apparatus comprising means for receiving information relating to at least one of policy and charging from at least one node, said information being associated with a traffic-offload function of a data connection.

27. An apparatus comprising means for enforcing policy and charging rules in a radio access network node for a traffic-offload function of a data connection.
